(19) United States
(12) Patent Application Publication
(10) Pub. No.: US 2025/0104660 A1
(43) Pub. Date: Mar. 27, 2025

(54) DRIVING METHOD FOR DISPLAY PANEL, DRIVING APPARATUS FOR DISPLAY PANEL, AND DISPLAY APPARATUS

(71) Applicants: Beijing BOE Optoelectronics Technology Co., Ltd., Beijing (CN); BOE Technology Group Co., Ltd., Beijing (CN)

(72) Inventors: Liguang DENG, Beijing (CN); Dong WANG, Beijing (CN); Gang HUA, Beijing (CN); Shaobo LI, Beijing (CN); Min WANG, Beijing (CN); Jintang HU, Beijing (CN); Liangliang PAN, Beijing (CN); Jinghao LIU, Beijing (CN); Jiahao BAI, Beijing (CN); Zhining LIN, Beijing (CN); Xinyu CHEN, Beijing (CN)

(21) Appl. No.: 18/701,853

(22) PCT Filed: Apr. 17, 2023
(86) PCT No.: PCT/CN2023/088756

§ 371 Date: Apr. 16, 2024

(30) Foreign Application Priority Data
Jun. 6, 2022 (CN) 202210629903.0

(51) Int. Cl. G09G 3/34

(52) U.S. Cl. CPC G09G 3/344; G09G 2310/0267; G09G 2310/0286; G09G 2310/08; G09G 2330/021

(57) ABSTRACT

A driving method for a display panel (100), a driving apparatus (200) for a display panel, and a display apparatus. The driving method includes: when in a first driving mode, determining a refresh region and a non-refresh region in a display panel (100) (S10); and inputting a first clock signal to a gate drive circuit (110) according to the refresh region and the non-refresh region, such that the gate drive circuit (110) outputs a first gate scan signal to a gate line in the non-refresh region, and outputs a second gate scan signal to a gate line in the refresh region (S20). The duration in which an active level of a first gate scan signal is maintained is less than the duration in which an active level of a second gate scan signal is maintained.

### CROSS REFERENCE TO RELATED APPLICATIONS

The present disclosure claims priority of Chinese patent application No. 202210629903.0, filed to the China National Intellectual Property Administration on Jun. 6, 2022, and entitled “Driving Method for Display Panel, Driving Apparatus for Display Panel, and Display Apparatus”, of which the entire contents are incorporated herein by reference.

### TECHNICAL FIELD

The present disclosure relates to the field of a display technology, in particular to a driving method for a display panel, a driving apparatus for the display panel, and a display apparatus.

### BACKGROUND

Nowadays, electronic paper mostly adopts an electrophoresis display (EPD) as a display panel. For consumers, the EPD has several major advantages. First, energy consumption is low, and second, the EPD belongs to a reflection type, thereby having good sunlight readability. Usually, the EPD presents a display effect by the movement of a colored charged ball in a liquid-state environment via an extra electric field, so as to show a display effect.

### SUMMARY

A driving method for a display panel, a driving apparatus for the display panel, and a display apparatus provided by embodiments of the present disclosure can shorten refresh time.

A driving method for a display panel provided by an embodiment of the present disclosure includes:
determining, when in a first driving mode, a refresh region and a non-refresh region in the display panel; and
inputting a first clock signal to a gate drive circuit in the display panel according to the refresh region and the non-refresh region, such that the gate drive circuit outputs a first gate scan signal to a gate line in the non-refresh region, and outputs a second gate scan signal to a gate line in the refresh region; where a duration in which an active level of the first gate scan signal is maintained is less than a duration in which an active level of the second gate scan signal is maintained.

In some examples, an active level of the first clock signal is used for outputting the active levels of the first gate scan signal and the second gate scan signal; and
the active level of the first clock signal for outputting the active level of the first gate scan signal is defined as a first active level, the active level of the first clock signal for outputting the active level of the second gate scan signal is defined as a second active level, and a duration in which the first active level is maintained is less than a duration in which the second active level is maintained.

In some examples, a clock period where the first active level is located is smaller than a clock period where the second active level is located.

In some examples, the gate drive circuit includes a plurality of shift registers, one shift register is coupled with one gate line, the plurality of shift registers are divided into a plurality of register groups, and the same register group receives the same first clock signal; and, at least one gate line coupled with other register groups are provided between gate lines coupled with two adjacent shift registers in the same register group; and
inputting the first clock signal to the gate drive circuit in the display panel according to the refresh region and the non-refresh region, such that the gate drive circuit outputs the first gate scan signal to the gate line in the non-refresh region, and outputs the second gate scan signal to the gate line in the refresh region includes:
inputting the first clock signal having the first active level and the second active level to the same register group according to the refresh region and the non-refresh region, such that the same register group outputs the first gate scan signal to a gate line coupled thereto located in the non-refresh region, and outputs the second gate scan signal to a gate line coupled thereto located in the refresh region.

In some examples, for the first clock signal input to the same register group, the duration in which the first active level is maintained is not greater than ½ of the duration in which the second active level is maintained.

In some examples, durations in which the first active levels of the first clock signals input to the different register groups are maintained are the same;
and/or, durations in which the second active levels of the first clock signals input to the different register groups are maintained are the same.

In some examples, the first clock signal includes a 1st first clock signal to an 8th first clock signal;
the plurality of register groups include a 1st register group to an 8th register group, wherein the 1st register group is coupled with an (8k−7)^{th} gate line; the 2nd register group is coupled with an (8k−6)^{th} gate line; the 3rd register group is coupled with an (8k−5)^{th} gate line; the 4th register group is coupled with an (8k−4)^{th} gate line; the 5th register group is coupled with an (8k−3)^{th} gate line; the 6th register group is coupled with an (8k−2)^{th} gate line; the 7th register group is coupled with an (8k−1)^{th} gate line; the 8th register group is coupled with an (8k)^{th} gate line; k is an integer larger than 0; and
the at least one first clock signal from the 1st first clock signal to the 8th first clock signal has the first active level and the second active level.

In some examples, the driving method further includes:
loading a data line with a set fixed voltage when outputting the active level of the first gate scan signal to the gate line in the non-refresh region, such that a pixel keeps a display image; and

loading the data line with a drive data voltage when outputting the active level of the second gate scan signal to the gate line in the refresh region, such that the pixel refreshes the display image.

In some examples, the display panel includes a common electrode; and
the driving method further includes: loading the common electrode with a common electrode voltage,
the set fixed voltage is the common electrode voltage.

In some examples, the driving method further includes:
inputting a second clock signal to the gate drive circuit in the display panel when in a second driving mode, such that the gate drive circuit outputs a third gate scan signal to each gate line, and loading a data line with a drive data voltage when outputting an active level of the third gate scan signal to the gate line, such that the pixel refreshes the display image, wherein durations in which active levels of various third gate scan signals are maintained are the same.

In some examples, the display panel includes an electrophoresis display.

A driving apparatus for a display panel provided by the embodiments of the present disclosure includes:
a determining circuit, configured to determine, when in a first driving mode, a refresh region and a non-refresh region in the display panel; and
a clock output circuit, configured to input a first clock signal to a gate drive circuit in the display panel according to the refresh region and the non-refresh region, such that the gate drive circuit outputs a first gate scan signal to a gate line in the non-refresh region, and outputs a second gate scan signal to a gate line in the refresh region; where a duration in which an active level of the first gate scan signal is maintained is less than a duration in which an active level of the second gate scan signal is maintained.

In some examples, the driving apparatus further includes: a source drive circuit; and
the source drive circuit is configured to load a data line with a set fixed voltage when outputting the active level of the first gate scan signal to the gate line in the non-refresh region, such that the pixel keeps a display image; and load the data line with a drive data voltage when outputting the active level of the second gate scan signal to the gate line in the refresh region, such that the pixel refreshes the display image.

A display apparatus provided by the embodiments of the present disclosure provides includes a display panel and the driving apparatus for the display panel above.

According to the driving method for the display panel, the driving apparatus for the display panel and the display apparatus, by determining the refresh region and the non-refresh region in the display panel, the first clock signal may be input to the gate drive circuit according to the determined refresh region and non-refresh region, such that the gate drive circuit may output the different gate scan signals to the gate lines in the non-refresh region and the refresh region, that is, the first gate scan signal is output to the gate line in the non-refresh region, and the second gate scan signal is output to the gate line in the refresh region. The duration in which the active level of the first gate scan signal is maintained is made to be less than the duration in which the active level of the second gate scan signal is maintained, in this way, scanning time of the non-refresh region may be shortened, and thus, the overall scanning time is shortened.

### BRIEF DESCRIPTION OF FIGURES

FIG. 1 is a schematic structural diagram of a display apparatus in an embodiment of the present disclosure.

FIG. 2 is a schematic structural diagram of a display panel in an embodiment of the present disclosure.

FIG. 3 is a partial section schematic structural diagram of a display panel in an embodiment of the present disclosure.

FIG. 4 is a schematic diagram of some of a structure of a shift register in an embodiment of the present disclosure.

FIG. 5 is a timing chart of some signal in an embodiment of the present disclosure.

FIG. 6 is a schematic structural diagram of a gate drive circuit in an embodiment of the present disclosure.

FIG. 7 is a schematic diagram of some specific structure of a gate drive circuit in an embodiment of the present disclosure.

FIG. 8A is another schematic diagram of some specific structure of a gate drive circuit in an embodiment of the present disclosure.

FIG. 8B is yet schematic diagram of some specific structure of a gate drive circuit in an embodiment of the present disclosure.

FIG. 8C is yet schematic diagram of some specific structure of a gate drive circuit in an embodiment of the present disclosure.

FIG. 8D is yet schematic diagram of some specific structure of a gate drive circuit in an embodiment of the present disclosure.

FIG. 9 is another timing chart of some signal in an embodiment of the present disclosure.

FIG. 10 is a flow chart of a driving method in an embodiment of the present disclosure.

FIG. 11 is yet another timing chart of some signal in an embodiment of the present disclosure.

### DETAILED DESCRIPTION

In order to make the objectives, technical solutions and advantages of embodiments of the present disclosure more clear, the technical solutions of the embodiments of the present disclosure will be described clearly and completely with reference to drawings of the embodiments of the present disclosure. Apparently, the described embodiments are part of the embodiments of the present disclosure, not all of them. The embodiments in the present disclosure and features in the embodiments may be combined with each other in the case of no conflict. On the basis of the described embodiments of the present disclosure, all other embodiments obtained by those ordinarily skilled in the art without inventive efforts fall within the scope of protection of the present disclosure.

Unless otherwise defined, technical or scientific terms used in the present disclosure shall have the usual meanings understood by those ordinarily skilled in the art to which the present disclosure pertains. “First” and “second” and similar words used in the present disclosure do not represent any sequence, quantity or importance, but are only used to distinguish different constituent parts. “Including” or “containing” and similar words used in the present disclosure mean that an element or item preceding the word covers an element or item listed after the word and the equivalent thereof, without excluding other elements or items. “Coupling” or “connection” and similar words are not limited to physical or mechanical coupling, but may include electrical coupling, whether direct or indirect.

It needs to be noted that sizes and shapes of all figures in the drawings do not reflect true scales, and are only intended to schematically illustrate the content of the present disclosure. The same or similar reference numerals represent the same or similar elements or elements with the same or similar functions all the time.

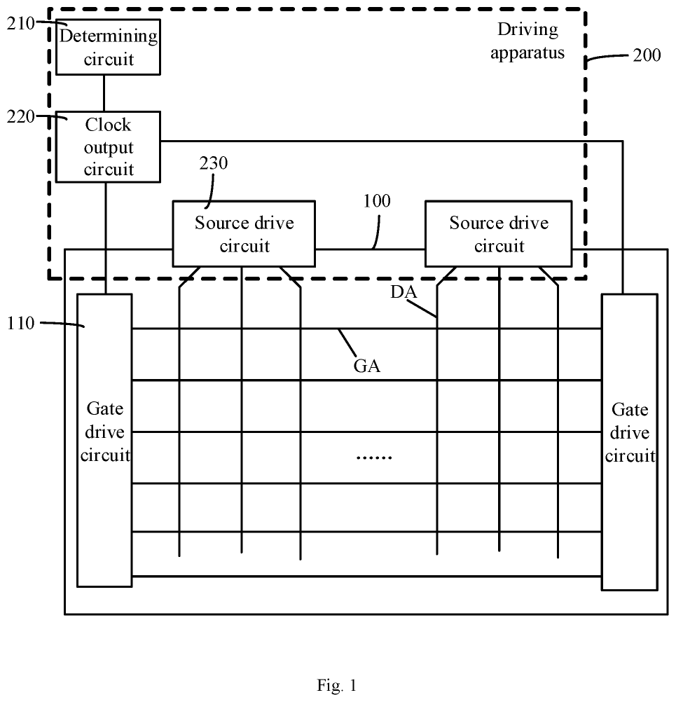

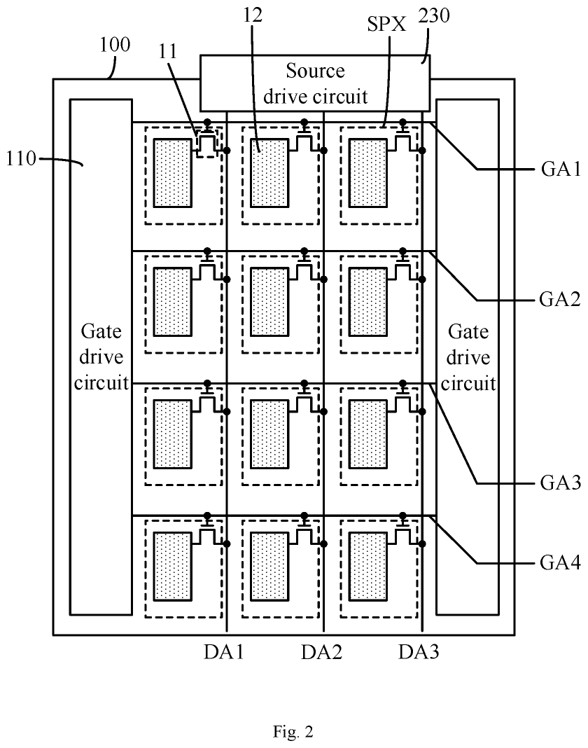

Referring to FIG. 1 and FIG. 2, a display apparatus may include a display panel 100 and a driving apparatus 200 of the display panel. The display panel 100 may include a plurality of pixels distributed in an array, a plurality of gate lines GA (such as GA1, GA2, GA3, and GA4), a plurality of data lines DA (such as DA1, DA2, and DA3) and a gate drive circuit 110. The gate drive circuit 110 is coupled with the gate lines GA1, GA2, GA3, and GA4 respectively. The driving apparatus 200 may include: a determining circuit 210, a clock output circuit 220 and a source drive circuit 230. The source drive circuit 230 is coupled with the data lines DA1, DA2, and DA3 respectively. Exemplarily, two source drive circuits 230 may be set, one source drive circuit 230 is coupled with half the quantity of data lines, and the other source drive circuit 230 is coupled with the other half the quantity of data lines. Of course, three, four or more source drive circuits 230 may also be set, which may be designed and determined according to the needs of actual application, and is not limited herein.

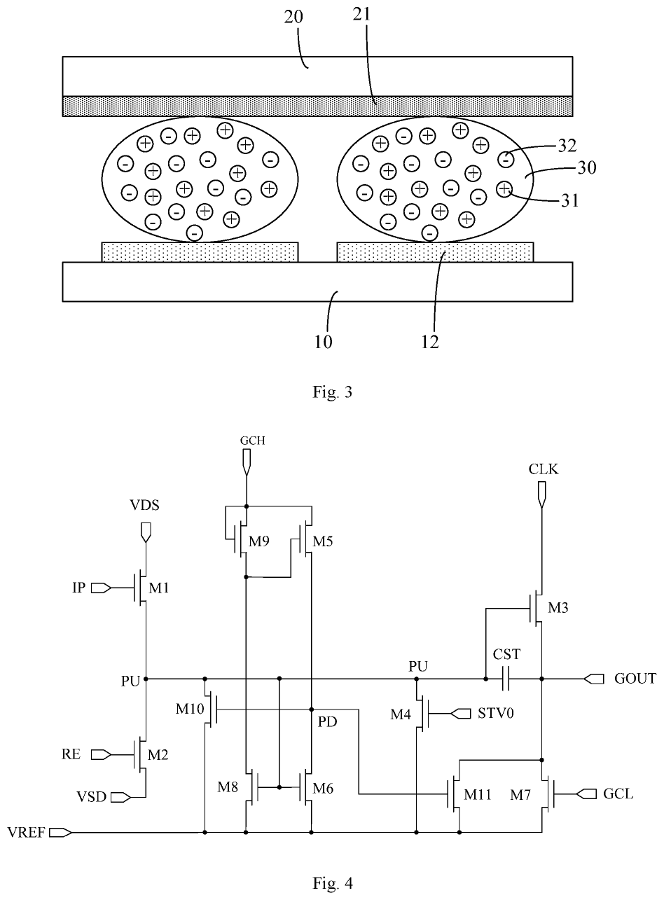

Referring to FIG. 2 and FIG. 3, each pixel SPX includes a transistor 11 and a drive electrode 12. One row of pixels SPX correspond to one gate line, and one column of pixels SPX correspond to one data line. A gate of the transistor 11 is coupled with a corresponding gate line, a source of the transistor 11 is coupled with a corresponding data line, and a drain of the transistor 11 is coupled with the drive electrode 12. It needs to be noted that the present disclosure does not limit a specific pixel distribution structure and distribution modes of the data lines and scan lines.

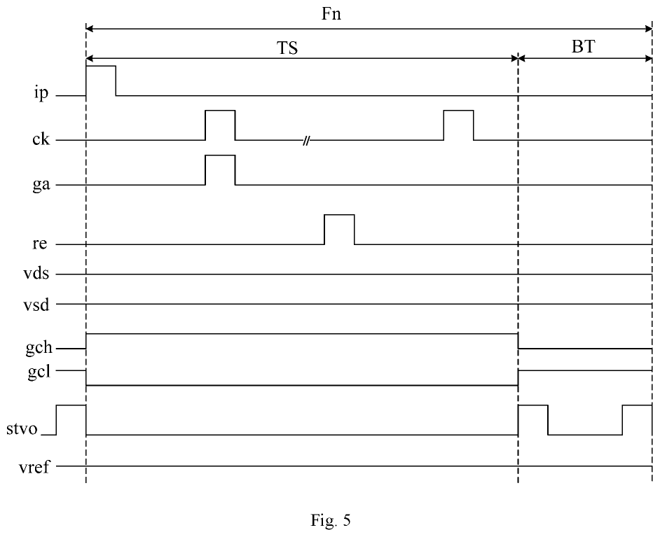

In some embodiments of the present disclosure, the gate drive circuit may include a plurality of shift registers, and one shift register is coupled with one gate line. Exemplarily, as shown in FIG. 4, each shift register may include switching transistors M1-M11 and a storage capacitor CST. In addition, the shift registers are coupled with an input signal end IP, a reset signal end RE, a clock signal end CLK, a reference voltage end VREF, a first scan control end VDS, a second scan control end VSD, a pull-down control end GCH, a noise reduction control end GCL, a frame reset signal end STVO, a drive output end GOUT, a first node PU and a second node PD. A signal timing chart corresponding to a shift register shown in FIG. 4 working in an nth frame Fn is as shown in FIG. 5, and the specific working process is basically the same with that in the related art, which is not repeated here. TS represents a scan stage, and BT represents a blanking time stage. ip represents a signal at the input signal end IP, ck represents a signal at the clock signal end CLK, ga represents a gate scan signal at the drive output end GOUT, re represents a signal at the reset signal end RE, vds represents a signal at the first scan control end VDS, vsd represents a signal at the second scan control end VSD, gch represents a signal at the pull-down control end GCH, gcl represents a signal at the noise reduction control end GCL, stvo represents a signal at the frame reset signal end STVO, and vref represents a signal at the reference voltage end VREF. Exemplarily, the drive output end GOUT is coupled with the corresponding gate line. An active level of the gate scan signal ga may control the transistor in the pixel coupled with the corresponding gate line to be turned on, and an inactive level of the gate scan signal ga may control the transistor in the pixel coupled with the corresponding gate line to be turned off. For example, the switching transistors M1-M11 are N-type transistors, the active level of the gate scan signal ga may be a high level, the inactive level of the gate scan signal ga is a low level, and the signal vref is a fixed voltage of the low level. Alternatively, the switching transistors M1-M11 are P-type transistors, the active level of the gate scan signal ga may also be the low level, the inactive level of the gate scan signal ga is the high level, and the signal vref is a fixed voltage of the high level, which is not limited here.

It needs to be noted that in the above shift registers provided by the embodiments of the present disclosure, the switching transistors M1 and M2 are symmetrically designed, function interchange may be achieved, and thus, the above shift registers provided by the embodiment of the present disclosure may achieve bidirectional scan. During forward scan, the switching transistor M1 serves as a transistor for inputting, and the switching transistor M2 serves as a transistor for resetting. Moreover, taking an example that the active level of the gate scan signal ga is the high level and the inactive level of the gate scan signal ga is the low level, the signal vds at the first scan control end VDS is a fixed voltage with the high level, and the signal vsd at the second scan control end VSD is a fixed voltage with the low level. During reverse scan, the switching transistor M2 serves as the transistor for inputting, and the switching transistor M1 serves as the transistor for resetting. Moreover, taking an example that the active level of the gate scan signal ga is the high level and the inactive level of the gate scan signal ga is the low level, the signal vds at the first scan control end VDS is the fixed voltage with the low level, and the signal vsd at the second scan control end VSD is the fixed voltage with the low level.

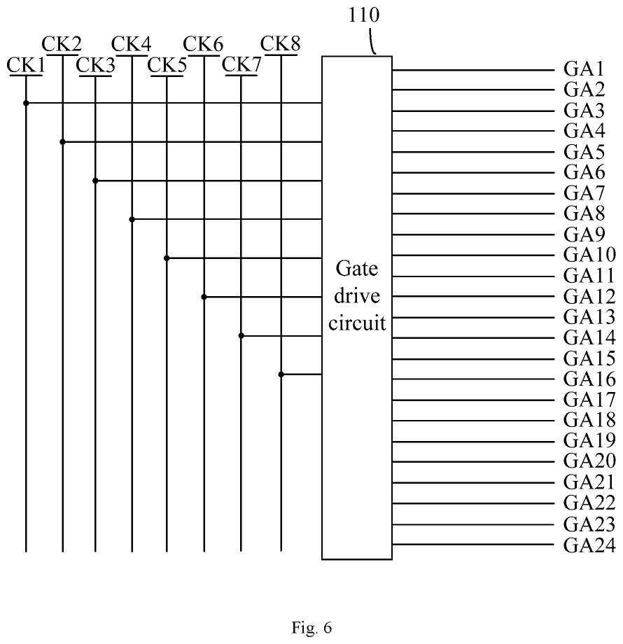

In some embodiments of the present disclosure, the display panel may further include a plurality of clock signal lines and a plurality of frame start signal lines, and the plurality of clock signal lines and the plurality of frame start signal lines are coupled with the gate drive circuit respectively. In this way, corresponding clock signals may be input to the gate drive circuit through the clock signal lines, the clock signals are input to clock signal ends of the shift registers, such that the shift registers output the gate scan signals to the coupled gate lines. Exemplarily, as shown in FIG. 6, the display panel may include eight clock signal lines CK1-CK8, and the eight clock signal lines CK1-CK8 are coupled with the gate drive circuit 110. It needs to be noted that FIG. 4 only illustrates by taking the eight clock signal lines as an example, in practical application, the specific quantity of the clock signal lines may be determined according to needs of the practical application, which is not limited here, for example, other quantity of clock signal lines may also be integer multiples of 2, such as 2, 4, 6, 10 and 12 clock signal lines.

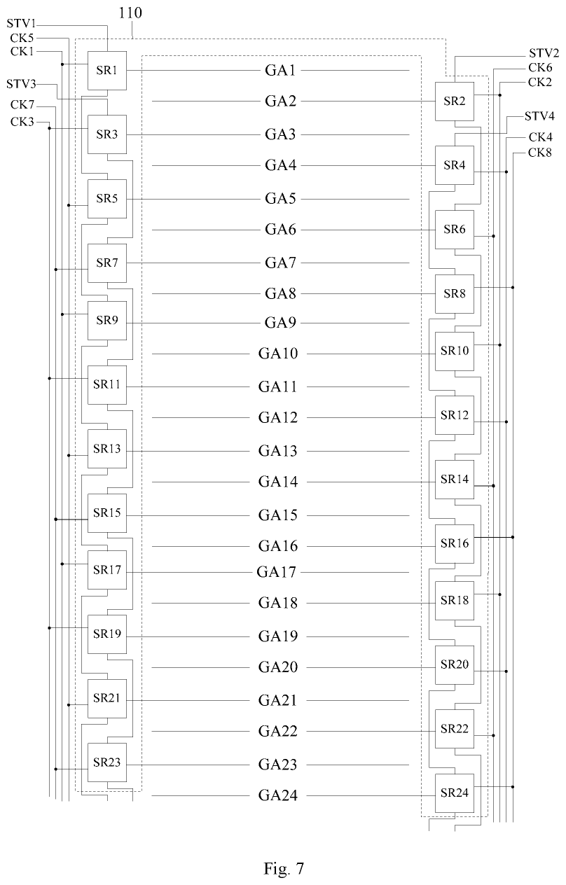

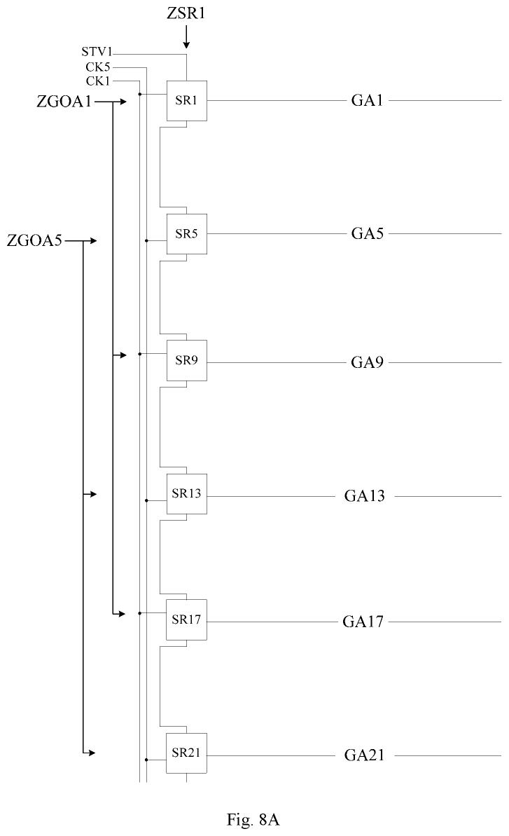

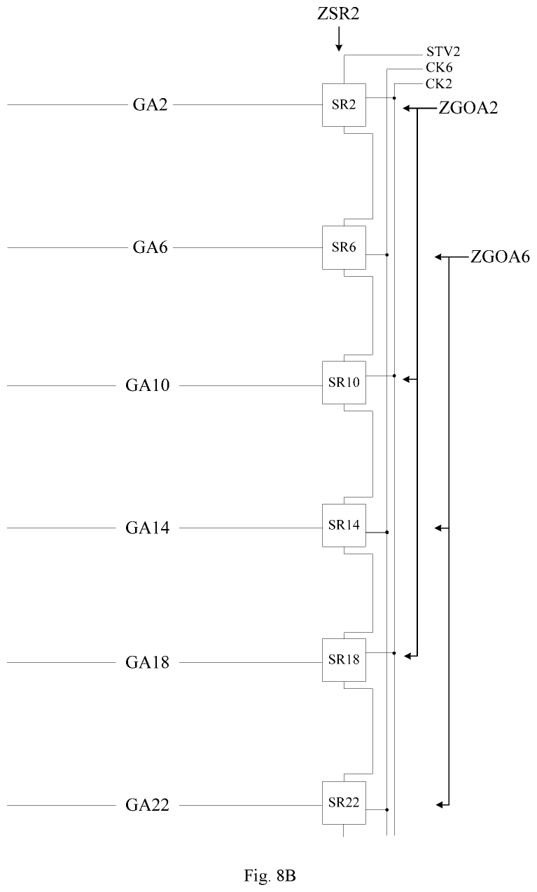

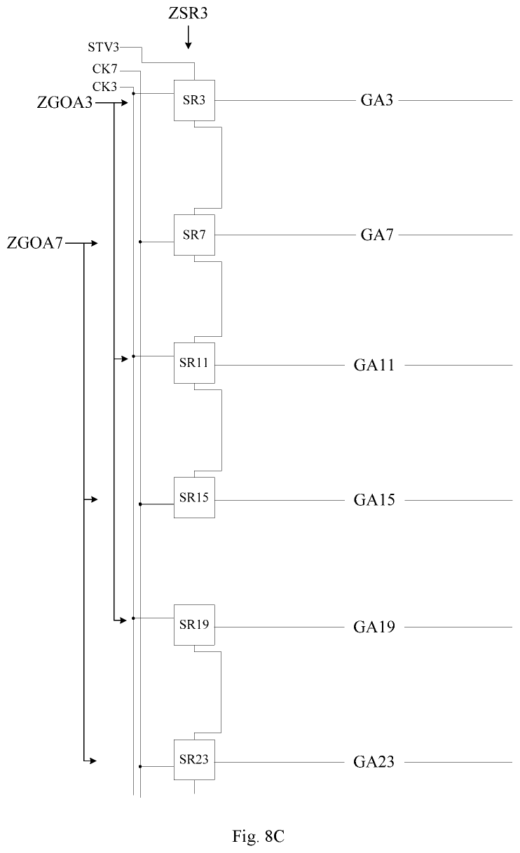

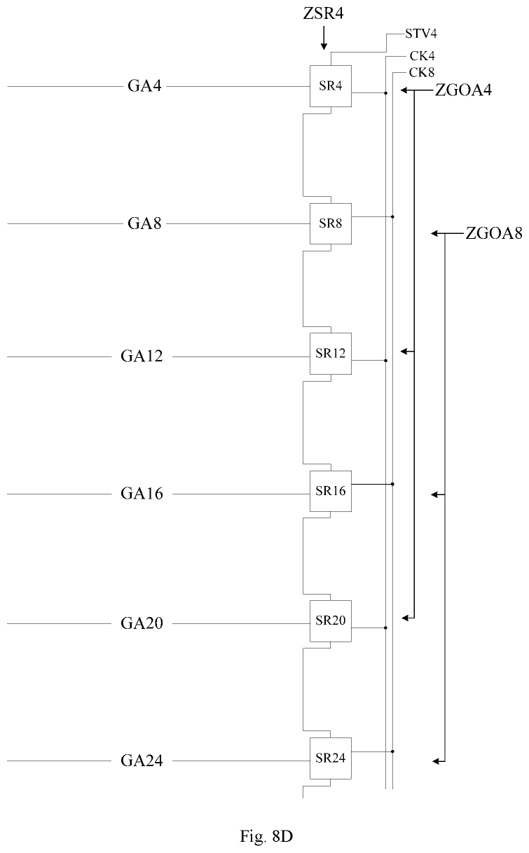

In some embodiments of the present disclosure, the shift registers in the gate drive circuit are divided into a plurality of cascade groups. The shift registers in the same cascade group are arranged in a cascade mode. Moreover, different cascade groups are coupled with different frame start signal lines. In addition, the plurality of shift registers are divided into a plurality of register groups, and the same register group is coupled with the same clock signal line. At least one gate line coupled with other register groups is provided between the gate lines coupled with two adjacent shift registers in the same register group. Exemplarily, taking the gate lines GA1-GA24 and the clock signal lines CK1-CK8 as an example, as shown in FIG. 7 to FIG. 8D, the gate drive circuit 110 includes shift registers SR1-SR24, a drive output end GOUT of the shift register SR1 is coupled with the gate line GA1, a drive output end GOUT of the shift register SR2 is coupled with the gate line GA2, a drive output end GOUT of the shift register SR3 is coupled with the gate line GA3, . . . , a drive output end GOUT of the shift register SR23 is coupled with the gate line GA23, and a drive output end GOUT of the shift register SR24 is coupled with the gate line GA24. The shift registers SR1-SR24 are divided into four cascade groups ZSR1-ZSR4. The cascade group ZSR1 is coupled with the frame start signal line STV1, the cascade group ZSR2 is coupled with the frame start signal line STV2, the cascade group ZSR3 is coupled with the frame start signal line STV3, and the cascade group ZSR4 is coupled with the frame start signal line STV4. In addition, the plurality of shift registers are divided into eight register groups: the 1st register group to the 8th register group ZGOA1-ZGOA8, the shift register in the 1st register group ZGOA1 is coupled with the clock signal line CK1, the shift register in the 2nd register group ZGOA2 is coupled with the clock signal line CK2, the shift register in the 3rd register group ZGOA3 is coupled with the clock signal line CK3, the shift register in the 4th register group ZGOA4 is coupled with the clock signal line CK4, the shift register in the 5th register group ZGOA5 is coupled with the clock signal line CK5, the shift register in the 6th register group ZGOA6 is coupled with the clock signal line CK6, the shift register in the 7th register group ZGOA7 is coupled with the clock signal line CK7, and the shift register in the 8th register group ZGOA8 is coupled with the clock signal line CK8. The 1st register group ZGOA1 is coupled with the (8k−7)^{th} gate line; the 2nd register group ZGOA2 is coupled with the (8k−6)^{th} gate line; the 3rd register group ZGOA3 is coupled with the (8k−5)^{th} gate line; the 4th register group ZGOA4 is coupled with the (8k−4)^{th} gate line; the 5th register group ZGOA5 is coupled with the (8k−3)^{th} gate line; the 6th register group ZGOA6 is coupled with the (8k−2)^{th} gate line; the 7th register group ZGOA7 is coupled with the (8k−1)^{th} gate line; the eighth register group ZGOA8 is coupled with the (8k)^{th} gate line; and k is an integer larger than 0.

Exemplarily, as shown in FIG. 7 and FIG. 8A, the cascade group ZSR1 includes the shift registers SR1, SR5, SR9, SR13, SR17 and SR21. An input signal end IP of the shift register SR1 is coupled with the frame start signal line STV1, the drive output end GOUT of the shift register SR1 is coupled with an input signal end IP of the shift register SR5, and the drive output end GOUT of the shift register SR5 is coupled with a reset signal end RE of the shift register SR1. The drive output end GOUT of the shift register SR5 is coupled with an input signal end IP of the shift register SR9, and the drive output end GOUT of the shift register SR9 is coupled with a reset signal end RE of the shift register SR5. The same can be said for the rest, and so on, which is not repeated here. In addition, the 1st register group ZGOA1 includes the shift registers SR1, SR9, and SR17. Clock signal ends of the shift registers SR1, SR9, and SR17 are all coupled with the clock signal line CK1. The 5th register group ZGOA5 includes the shift registers SR5, SR13, and SR21. Clock signal ends of the shift registers SR5, SR13, and SR21 are all coupled with the clock signal line CK5.

Exemplarily, as shown in FIG. 7 and FIG. 8B, the cascade group ZSR2 includes the shift registers SR2, SR6, SR10, SR14, SR18 and SR22. An input signal end IP of the shift register SR2 is coupled with the frame start signal line STV2, the drive output end GOUT of the shift register SR2 is coupled with an input signal end IP of the shift register SR6, and the drive output end GOUT of the shift register SR6 is coupled with a reset signal end RE of the shift register SR2. The drive output end GOUT of the shift register SR6 is coupled with an input signal end IP of the shift register SR10, and the drive output end GOUT of the shift register SR10 is coupled with a reset signal end RE of the shift register SR6. The same can be said for the rest, and so on, which is not repeated here. In addition, the second register group ZGOA2 includes the shift registers SR2, SR10, and SR18. Clock signal ends of the shift registers SR2, SR10, and SR18 are all coupled with the clock signal line CK2. The 6th register group ZGOA6 includes the shift registers SR6, SR14, and SR22. Clock signal ends of the shift registers SR6, SR14, and SR22 are all coupled with the clock signal line CK6.

Exemplarily, as shown in FIG. 7 and FIG. 8C, the cascade group ZSR3 includes the shift registers SR3, SR7, SR11, SR15, SR19 and SR23. An input signal end IP of the shift register SR3 is coupled with the frame start signal line STV3, the drive output end GOUT of the shift register SR3 is coupled with an input signal end IP of the shift register SR7, and the drive output end GOUT of the shift register SR7 is coupled with a reset signal end RE of the shift register SR3. The drive output end GOUT of the shift register SR7 is coupled with an input signal end IP of the shift register SR11, and the drive output end GOUT of the shift register SR11 is coupled with a reset signal end RE of the shift register SR7. The same can be said for the rest, and so on, which is not repeated here. In addition, the 3rd register group ZGOA3 includes the shift registers SR3, SR11, and SR19. Clock signal ends of the shift registers SR3, SR11, and SR19 are all coupled with the clock signal line CK3. The 7th register group ZGOA7 includes the shift registers SR7, SR15, and SR23. Clock signal ends of the shift registers SR7, SR15, and SR23 are all coupled with the clock signal line CK7.

Exemplarily, as shown in FIG. 7 and FIG. 8D, the cascade group ZSR4 includes the shift registers SR4, SR8, SR12, SR16, SR20 and SR24. An input signal end IP of the shift register SR4 is coupled with the frame start signal line STV4, the drive output end GOUT of the shift register SR4 is coupled with an input signal end IP of the shift register SR8, and the drive output end GOUT of the shift register SR8 is coupled with a reset signal end RE of the shift register SR4. The drive output end GOUT of the shift register SR8 is coupled with the input signal end IP of the shift register SR12, and the drive output end GOUT of the shift register SR12 is coupled with a reset signal end RE of the shift register SR8. The same can be said for the rest, and so on, which is not repeated here. In addition, the 4th register group ZGOA4 includes the shift registers SR4, SR12, and SR20. Clock signal ends of the shift registers SR4, SR12, and SR20 are all coupled with the clock signal line CK4. The 8th register group ZGOA8 includes the shift registers SR8, SR16, and SR24. Clock signal ends of the shift registers SR8, SR16, and SR24 are all coupled with the clock signal line CK8.

In some embodiments of the present disclosure, when it is determined that a second driving mode is adopted, a second clock signal may be input to the gate drive circuit in the display panel, such that the gate drive circuit outputs a third gate scan signal to each gate line, and when an active level of the third gate scan signal is output to the gate line, a data line is loaded with a drive data voltage, such that a pixel refreshes a display image, where durations in which the active levels of the third gate scan signals are maintained are the same. Exemplarily, the active level of the second clock signal is used for outputting the active level of the third clock signal. Optionally, durations in which the active levels of the second clock signals are maintained are the same. Optionally, clock periods of the second clock signals are the same.

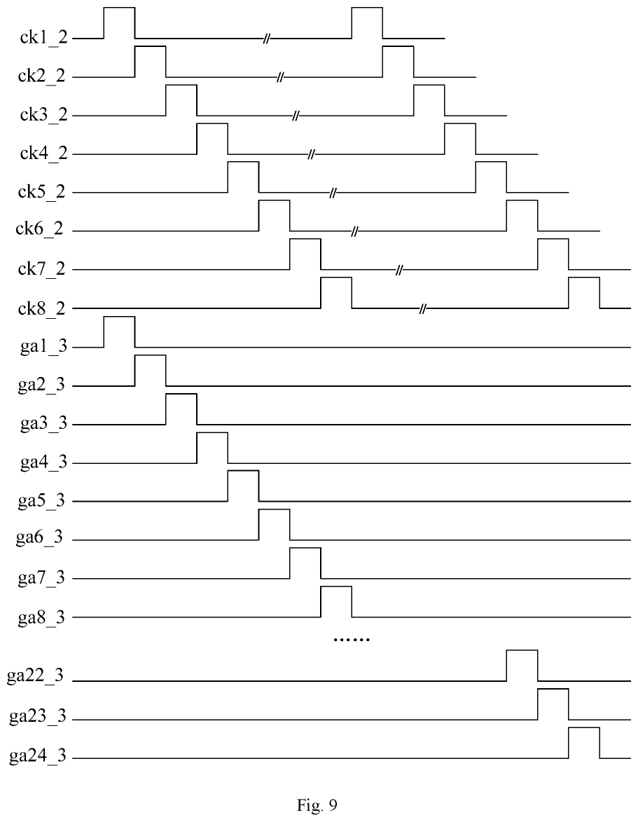

Exemplarily, when in the second driving mode, the same register group receives the same second clock signal. A signal timing chart corresponding to a gate drive circuit shown in FIG. 7 is as shown in FIG. 9. Herein, ck1_2 represents the second clock signal input to the clock signal line CK1, ck2_2 represents the second clock signal input to the clock signal line CK2, ck3_2 represents the second clock signal input to the clock signal line CK3, ck4_2 represents the second clock signal input to the clock signal line CK4, ck5_2 represents the second clock signal input to the clock signal line CK5, ck6_2 represents the second clock signal input to the clock signal line CK6, ck7_2 represents the second clock signal input to the clock signal line CK7, and ck8_2 represents the second clock signal input to the clock signal line CK8. In addition, ck1_2 serves as a 1st second clock signal, ck2_2 serves as a 2nd second clock signal, ck3_2 serves as a 3rd second clock signal, ck4_2 serves as a 4th second clock signal, ck5_2 serves as a 5th second clock signal, ck6_2 serves as a 6th second clock signal, ck7_2 serves as a 7th second clock signal, and ck8_2 serves as an 8th second clock signal.

In addition, a signal ga1_3 represents a third gate scan signal output by the gate drive circuit 110 to the gate line GA1, a signal ga2_3 represents a third gate scan signal output by the gate drive circuit 110 to the gate line GA2, . . . , a signal ga22_3 represents a third gate scan signal output by the gate drive circuit 110 to the gate line GA22, a signal ga23_3 represents a third gate scan signal output by the gate drive circuit 110 to the gate line GA23, and a signal ga24_3 represents a third gate scan signal output by the gate drive circuit 110 to the gate line GA24. In addition, taking an example that the high level is the active level of the third gate scan signal, the shift register SR1 outputs a first high level of the 1st second clock signal ck1_2 to the gate line GA1, to generate a high level in the third gate scan signal ga1_3. The shift register SR2 outputs a first high level of the 2nd second clock signal ck2_2 to the gate line GA2, to generate a high level in the third gate scan signal ga2_3. The shift register SR3 outputs a first high level of the 3rd second clock signal ck3_2 to the gate line GA3, to generate a high level in the third gate scan signal ga3_3. The shift register SR4 outputs a first high level of the 4th second clock signal ck4_2 to the gate line GA4, to generate a high level in the third gate scan signal ga4_3. The shift register SR5 outputs a first high level of the 5th second clock signal ck5_2 to the gate line GA5, to generate a high level in the third gate scan signal ga5_3. The shift register SR6 outputs a first high level of the 6th second clock signal ck6_2 to the gate line GA6, to generate a high level in the third gate scan signal ga6_3. The shift register SR7 outputs a first high level of the 7th second clock signal ck7_2 to the gate line GA7, to generate a high level in the third gate scan signal ga7_3. The shift register SR8 outputs a first high level of the 8th second clock signal ck8_2 to the gate line GA8, to generate a high level in the third gate scan signal ga8_3. The shift register SR9 outputs a second high level of the 1st second clock signal ck1_2 to the gate line GA9, to generate a high level in the third gate scan signal ga9_3. The shift register SR10 outputs a second high level of the 2nd second clock signal ck2_2 to the gate line GA10, to generate a high level in the third gate scan signal ga10_3. The shift register SR11 outputs a second high level of the 3rd second clock signal ck3_2 to the gate line GA11, to generate a high level in the third gate scan signal ga11_3. The shift register SR12 outputs a second high level of the 4th second clock signal ck4_2 to the gate line GA12, to generate a high level in the third gate scan signal ga12_3. The shift register SR13 outputs a second high level of the 5th second clock signal ck5_2 to the gate line GA13, to generate a high level in the third gate scan signal ga13_3. The shift register SR14 outputs a second high level of the 6th second clock signal ck6_2 to the gate line GA14, to generate a high level in the third gate scan signal ga14_3. The shift register SR15 outputs a second high level of the 7th second clock signal ck7_2 to the gate line GA15, to generate a high level in the third gate scan signal ga15_3. The shift register SR16 outputs a second high level of the 8th second clock signal ck8_2 to the gate line GA16, to generate a high level in the third gate scan signal ga16_3. The same can be said for the rest, and so on, which is not repeated here.

That is to say, durations in which the high levels of the second clock signals ck1_2-ck8_2 are maintained are the same, and the clock periods of the second clock signals ck1_2-ck8_2 are the same. In addition, the high levels of the second clock signals ck1_2-ck8_2 may be active levels thereof, and low levels of the second clock signals ck1_2-ck8_2 are idler pulses thereof. Of course, when the shift registers output the low levels of the second clock signals so as to generate low level signals in the third gate scan signals for controlling the transistors to be turned on, the low levels of the second clock signals may serve as the active levels thereof, and the high levels of the second clock signals serve as the idler pulses thereof.

The EPD has several major advantages, first, energy consumption is low, and second, the EPD belongs to a reflection type, thereby having good sunlight readability. The display panel provided by the embodiments of the present disclosure may be set as an electrophoresis display. Exemplarily, as shown in FIG. 3, the EPD generally includes an array substrate 10 and an opposite substrate 20 which are arranged oppositely, and a plurality of microcapsules 30 arranged between the array substrate 10 and the opposite substrate 20. A plurality of pixels are arranged on the array substrate 10, and each pixel has a drive electrode 12 and a transistor (not shown in FIG. 3). A common electrode 21 is arranged on the opposite substrate 20. In addition, each microcapsule 30 contains white ink particles 31 charged with a negative (−) or positive (+) potential (FIG. 3 takes an example that the white ink particles 31 are charged with a positive potential), black ink particles 32 charged with a potential opposite to that of the white ink particles 31, and a transparent dielectric medium. For example, if the white ink particles 31 are charged with the positive potential (+), the black ink particles 32 are charged with the negative potential (−). One pixel is correspondingly provided with one microcapsule 30, a common electrode voltage is loaded on the common electrode 21, and a drive data voltage is loaded on the drive electrode 12, such that an electric field is formed between the common electrode 21 and the drive electrode 12. If the common electrode voltage is 0 V, the drive data voltage is +16 V, the white ink particles 31 are gathered to the common electrode 21, the black ink particles 32 are gathered to the drive electrode 12, and the pixel displays white due to the action of reflecting ambient light. If the common electrode voltage is 0 V, the drive data voltage is-16 V, the white ink particles 31 are gathered to the drive electrode 12, the black ink particles 32 are gathered to the common electrode 21, and the pixel displays black due to the action of reflecting the ambient light.

Usually, the EPD only needs electricity during refresh, and has advantages of saving energy and not damaging eyesight compared with a high-speed response display device with dozens of refreshes per second. At present, the EPD is mainly applied to an electronic price tag, an item name displayed on the electronic price tag is unchanged most of the time, and usually corresponding item price only is adjusted. Therefore, for some application needs, an image may be displayed only by refreshing a part of region, and at this time, refreshing the entire image takes time and electricity. According to a driving method for the display panel provided by the embodiments of the present disclosure, by determining the refresh region and the non-refresh region in the display panel, the first clock signal may be input to the gate drive circuit according to the determined refresh region and non-refresh region, such that the gate drive circuit may output the different gate scan signals to the gate lines in the non-refresh region and the refresh region, that is, the first gate scan signal is output to the gate line in the non-refresh region, and the second gate scan signal is output to the gate line in the refresh region. Moreover, the duration in which the active level of the first gate scan signal is maintained is made to be less than the duration in which the active level of the second gate scan signal is maintained, in this way, scanning time of the non-refresh region may be shortened, and thus, the overall scanning time is shortened.

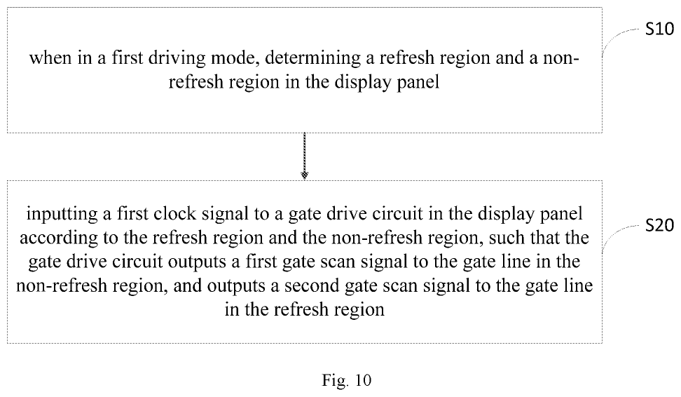

The embodiments of the present disclosure provide a driving method for a display panel, as shown in FIG. 10, including the following steps.

S10, when in a first driving mode, determining a refresh region and a non-refresh region in the display panel.

In some examples, taking an example that one row of pixels correspond to one gate line, when an EPD is an electronic price tag, an item name is usually displayed on an upper part region of the electronic price tag (namely an image not needing to be changed for a long time), a price of an item is displayed on a lower part region of the electronic price tag (namely an image needing to be changed for a short time), thus, a region corresponding to the image not needing to be changed for a long time in the upper part region of the electronic price tag may serve as the non-refresh region, and a region corresponding to the image needing to be changed for a short time in the lower part region may serve as the refresh region. For example, in conjunction with FIG. 6, taking the gate lines GA1-GA24 as an example, a region where the pixels coupled with the gate lines GA1-GA16 are located is the non-refresh region, and a region where the pixels coupled with the gate lines GA17-GA24 are located is the refresh region.

Alternatively, if the lower part region of the electronic price tag displays the item name, and the upper part region displays the price of the item, the upper part region of the electronic price tag may serve as the refresh region, and the lower part region serve as the non-refresh region. For example, in conjunction with FIG. 6, taking the gate lines GA1-GA24 as an example, a region where the pixels coupled with the gate lines GA1-GA8 are located is the refresh region, and a region where the pixels coupled with the gate lines GA9-GA24 are located is the non-refresh region.

S20, inputting a first clock signal to a gate drive circuit in the display panel according to the refresh region and the non-refresh region, such that the gate drive circuit outputs a first gate scan signal to the gate line in the non-refresh region, and outputs a second gate scan signal to the gate line in the refresh region. A duration in which an active level of the first gate scan signal is maintained is less than a duration in which an active level of the second gate scan signal is maintained.

In some examples, the active level of the first gate scan signal may control a transistor coupled with the corresponding gate line to be turned on, and an inactive level of the first gate scan signal may control the transistor coupled with the corresponding gate line to be turned off. Exemplarily, the active level of the first gate scan signal may be a high level, and the inactive level of the first gate scan signal is a low level. Alternatively, the active level of the first gate scan signal may also be a low level, and the inactive level of the first gate scan signal is a high level, which is not limited here.

In some examples, the active level of the second gate scan signal may control the transistor coupled with the corresponding gate line to be turned on, and the inactive level of the second gate scan signal may control the transistor coupled with the corresponding gate line to be turned off. Exemplarily, the active level of the second gate scan signal may be the high level, and the inactive level of the second gate scan signal is the low level. Alternatively, the active level of the second gate scan signal may also be the low level, and the inactive level of the second gate scan signal is the high level, which is not limited here.

In some examples, the active levels of the first gate scan signal and the second gate scan signal are both high levels, and the inactive levels of the first gate scan signal and the second gate scan signal are both low levels. Alternatively, the active levels of the first gate scan signal and the second gate scan signal are both low levels, and the inactive levels of the first gate scan signal and the second gate scan signal are both high levels, which is not limited here.

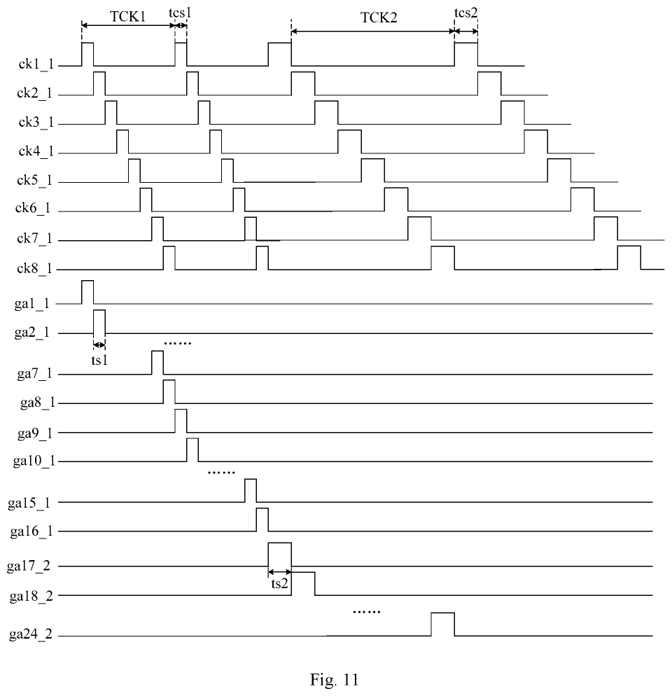

Illustration is made by taking an example that the region where the pixels coupled with the gate lines GA1-GA16 are located is the non-refresh region, the region where the pixels coupled with the gate lines GA17-GA24 are located is the refresh region, the active levels of the first gate scan signal and the second gate scan signal are both the high levels, and the inactive levels of the first gate scan signal and the second gate scan signal are both the low levels. Exemplarily, in conjunction with FIG. 7 and FIG. 11, ga1_1 represents the first gate scan signal output by the gate drive circuit 110 to the gate line GA1, ga2_1 represents the first gate scan signal output by the gate drive circuit 110 to the gate line GA2, ga3_1 represents the first gate scan signal output by the gate drive circuit 110 to the gate line GA3, . . . , ga15_1 represents the first gate scan signal output by the gate drive circuit 110 to the gate line GA15, ga16_1 represents the first gate scan signal output by the gate drive circuit 110 to the gate line GA16, ga17_2 represents the second gate scan signal output by the gate drive circuit 110 to the gate line GA17, ga18_2 represents the second gate scan signal output by the gate drive circuit 110 to the gate line GA18, . . . , ga24_2 represents the second gate scan signal output by the gate drive circuit 110 to the gate line GA24. In addition, durations in which high levels of the first gate scan signals ga1_1-ga16_1 are maintained are ts1, durations in which high levels of the second gate scan signals ga17_2-ga24_2 are maintained are ts2, and the durations ts1 in which the high levels of the first gate scan signals ga1_1-ga16_1 are maintained are less than the durations ts2 in which the high levels of the second gate scan signals ga17_2-ga24_2 are maintained.

In some embodiments of the present disclosure, an active level of the first clock signal input to the gate drive circuit is used for outputting the active levels of the first gate scan signal and the second gate scan signal. The first clock signal is input to clock signal ends of shift registers, and the shift registers may take the active level of the first clock signal as the active levels of the first gate scan signal and the second gate scan signal to be output through a driving output end. In addition, the active level of the first clock signal for outputting the active level of the first gate scan signal is defined as a first active level, the active level of the first clock signal for outputting the active level of the second gate scan signal is defined as a second active level, as shown in FIG. 11, a duration tcs1 in which the first active level is maintained is less than a duration tcs2 in which the second active level is maintained. For example, taking an example that the active level is the high level, the duration in which the high level serving as the first active level is maintained is less than the duration in which the high level serving as the second active level is maintained.

Optionally, as shown in FIG. 11, a clock period TCK1 where the first active level is located is smaller than a clock period TCK2 where the second active level is located. For example, taking an example that the active level is the high level, the clock period where the high level serving as the first active level is located is smaller than the clock period where the high level serving as the second active level is located.

In some embodiments of the present disclosure, the inputting the first clock signal to the gate drive circuit in the display panel according to the refresh region and the non-refresh region, such that the gate drive circuit outputs the first gate scan signal to the gate line in the non-refresh region, and outputs the second gate scan signal to the gate line in the refresh region, includes: inputting the first clock signal having the first active level and the second active level to the same register group according to the refresh region and the non-refresh region, such that the same register group outputs the first gate scan signal to the gate line coupled thereto located in the non-refresh region, and outputs the second gate scan signal to the gate line coupled thereto located in the refresh region. Exemplarily, for the first clock signal input to the same register group, the duration in which the first active level is maintained is not greater than ½ of the duration in which the second active level is maintained. Optionally, the durations in which the first active levels of the first clock signals input to different register groups are maintained are the same. Optionally, the durations in which the second active levels of the first clock signals input to the different register groups are maintained are the same.

Exemplarily, when in the first driving mode, the same register group receives the same first clock signal. A signal timing chart corresponding to the gate drive circuit shown in FIG. 7 is as shown in FIG. 11. ck1_1 represents a first clock signal input to a clock signal line CK1, ck2_1 represents a first clock signal input to a clock signal line CK2, ck3_1 represents a first clock signal input to a clock signal line CK3, ck4_1 represents a first clock signal input to a clock signal line CK4, ck5_1 represents a first clock signal input to a clock signal line CK5, ck6_1 represents a first clock signal input to a clock signal line CK6, ck7_1 represents a first clock signal input to a clock signal line CK7, and ck8_1 represents a first clock signal input to a clock signal line CK8. In addition, ck1_1 serves as the 1st first clock signal, ck2_1 serves as the 2nd first clock signal, ck3_1 serves as the 3rd first clock signal, ck4_1 serves as the 4th first clock signal, ck5_1 serves as the 5th first clock signal, ck6_1 serves as the 6th first clock signal, ck7_1 serves as the 7th first clock signal, and ck8_1 serves as the 8th first clock signal. Exemplarily, at least one first clock signal from the 1st first clock signal to the 8th first clock signal has the first active level and the second active level. Optionally, each first clock signal from the 1st first clock signal to the 8th first clock signal has the first active level and the second active level.

In addition, a signal ga1_1 represents the first gate scan signal output by the gate drive circuit 110 to the gate line GA1, a signal ga2_1 represents the first gate scan signal output by the gate drive circuit 110 to the gate line GA2, . . . , a signal ga15_1 represents the first gate scan signal output by the gate drive circuit 110 to the gate line GA15, a signal ga16_1 represents the first gate scan signal output by the gate drive circuit 110 to the gate line GA16, a signal ga17_2 represents the second gate scan signal output by the gate drive circuit 110 to the gate line GA17, a signal ga18_2 represents the second gate scan signal output by the gate drive circuit 110 to the gate line GA18, . . . , a signal ga24_2 represents the second gate scan signal output by the gate drive circuit 110 to the gate line GA24. In addition, taking an example that the high level is the active level of the first gate scan signal, the shift register SR1 outputs a first high level of the 1st first clock signal ck1_1 to the gate line GA1, to generate the high level in the first gate scan signal ga1_1. The shift register SR2 outputs a first high level of the 2nd first clock signal ck2_1 to the gate line GA2, to generate the high level in the first gate scan signal ga2_1. The shift register SR3 outputs a first high level of the 3rd first clock signal ck3_1 to the gate line GA3, to generate the high level in the first gate scan signal ga3_1. The shift register SR4 outputs a first high level of the 4th first clock signal ck4_1 to the gate line GA4, to generate the high level in the first gate scan signal ga4_1. The shift register SR5 outputs a first high level of the 5th first clock signal ck5_1 to the gate line GA5, to generate the high level in the first gate scan signal ga5_1. The shift register SR6 outputs a first high level of the 6th first clock signal ck6_1 to the gate line GA6, to generate the high level in the first gate scan signal ga6_1. The shift register SR7 outputs a first high level of the 7th first clock signal ck7_1 to the gate line GA7, to generate the high level in the first gate scan signal ga7_1. The shift register SR8 outputs a first high level of the 8th first clock signal ck8_1 to the gate line GA8, to generate the high level in the first gate scan signal ga8_1. The shift register SR9 outputs a second high level of the1st first clock signal ck1_1 to the gate line GA9, to generate the high level in the first gate scan signal ga9_1. The shift register SR10 outputs a second high level of the 2nd first clock signal ck2_1 to the gate line GA10, to generate the high level in the first gate scan signal ga10_1. The shift register SR11 outputs a second high level of the 3rd first clock signal ck3_1 to the gate line GA11, to generate the high level in the first gate scan signal ga11_1. The shift register SR12 outputs a second high level of the 4th first clock signal ck1_1 to the gate line GA12, to generate the high level in the first gate scan signal ga12_1. The shift register SR13 outputs a second high level of the 5th first clock signal ck5_1 to the gate line GA13, to generate the high level in the first gate scan signal ga13_1. The shift register SR14 outputs a second high level of the 6th first clock signal ck6_1 to the gate line GA14, to generate the high level of the first gate scan signal ga14_1. The shift register SR15 outputs a second high level of the 7th first clock signal ck7_1 to the gate line GA15, to generate the high level in the first gate scan signal ga15_1. The shift register SR16 outputs a second high level of the 8th first clock signal ck8_1 to the gate line GA16, to generate the high level in the first gate scan signal ga16_1. The shift register SR17 outputs a third high level of the 1st first clock signal ck1_1 to the gate line GA17, to generate the high level in the second gate scan signal ga17_2. The shift register SR18 outputs a third high level of the 2nd first clock signal ck2_1 to the gate line GA18, to generate the high level in the second gate scan signal ga18_2. The shift register SR19 outputs a third high level of the 3rd first clock signal ck3_1 to the gate line GA19, to generate the high level in the second gate scan signal ga19_2. The shift register SR20 outputs a third high level of the 4th first clock signal ck4_1 to the gate line GA20, to generate the high level in the second gate scan signal ga20_2. The shift register SR21 outputs a third high level of the 5th first clock signal ck5_1 to the gate line GA21, to generate the high level in the second gate scan signal ga21_2. The shift register SR22 outputs a third high level of the 6th first clock signal ck6_1 to the gate line GA22, to generate the high level in the second gate scan signal ga22_2. The shift register SR23 outputs a third high level of the 7th first clock signal ck7_1 to the gate line GA23, to generate the high level in the second gate scan signal ga23_2. The shift register SR24 outputs a third high level of the 8th first clock signal ck8_1 to the gate line GA24, to generate the high level in the second gate scan signal ga24_2.

That is to say, the high levels of the first clock signals ck1_1-ck8_1 may be the active levels thereof, and low levels may be idler pulses thereof. Of course, when the shift registers output the low levels of the first clock signals to generate the low level signals in the first gate scan signal and the second gate scan signal for controlling the transistor to be turned on, the low levels of the first clock signals may serve as the active levels thereof, and the high levels of the first clock signals may serve as the idler pulses thereof.

In some embodiments of the present disclosure, the driving method may further include: loading a data line with a set fixed voltage when outputting the active level of the first gate scan signal to the gate line in the non-refresh region, such that the pixel keeps a display an image. Exemplarily, the set fixed voltage is a common electrode voltage. During specific implementation, when the data line is loaded with the set fixed voltage, the active level of the first gate scan signal may control the transistor coupled with the corresponding gate line to be turned on, such that the set fixed voltage is input to a drive electrode of the corresponding pixel. Since the set fixed voltage on the drive electrode is the common electrode voltage, an electric field may be not generated between the drive electrode and the common electrode which are arranged oppositely, thus, white ink particles and black ink particles will not be driven to move, and thus, the pixel may keep a previous display state. For example, if the pixel displays black in an nth frame, when a second driving mode is adopted in an (n+1)^{th} frame, the electric field is not generated between the drive electrode and the common electrode which are arranged oppositely of the pixel, and the pixel keeps black display in the (n+1)^{th} frame. If the pixel displays white in the nth frame, when the second driving mode is adopted in the (n+1)^{th} frame, the electric field is not generated between the drive electrode and the common electrode which are arranged oppositely of the pixel, and the pixel keeps white display in the (n+1)^{th} frame. In this way, a better local refresh effect may be achieved.

In some embodiments of the present disclosure, the driving method may further include: loading the data line with a drive data voltage when outputting the active level of the second gate scan signal to the gate line in the refresh region, so as to make the pixel refresh the display image.

Exemplarily, the drive data voltage is different from the common electrode voltage. During specific implementation, when the data line is loaded with the drive data voltage, the active level of the second gate scan signal may control the transistor coupled with the corresponding gate line to be turned on, such that the drive data voltage is input to the drive electrode of the corresponding pixel. Since the drive data voltage on the drive electrode is different from the common electrode voltage, the electric field may be generated between the drive electrode and the common electrode which are arranged oppositely, so as to drive the white ink particles and the black ink particles to move, and thus, the pixel may refresh the display image. For example, if the pixel displays black in the n^{th} frame, when the second driving mode is adopted in the (n+1)^{th} frame, the electric field is generated between the drive electrode and the common electrode which are arranged oppositely of the pixel, and the pixel may display white in the (n+1)^{th} frame through refresh. If the pixel displays white in the nth frame, when the second driving mode is adopted in the (n+1)^{th} frame, the electric field is generated between the drive electrode and the common electrode which are arranged oppositely of the pixel, and the pixel may display black in the (n+1)^{th} frame through refresh.

It needs to be noted that for a conventional EPD electronic price tag product, its size is usually below 10 inches, the number of pixel rows is usually smaller than 1000, a drive frequency is usually 50 Hz, and thus charging time of each pixel row is greater than 20 us. Exemplarily, taking a 2.66-inch EPD product and the active level being the high level as an example, the EPD product has eight clock signal lines, the drive frequency is 50 Hz, the total number of the pixel rows is 320, time for each row is 62.5 us (containing a time slot of adjacent rows), a duration in which the high level serving as the first active level in the first clock signal is maintained is about 52 us (there is a time slot in adjacent rows), a first node PU in the shift register reaches a peak 20 V during first pull-up, but when the high level of the first clock signal does not appear, a voltage of the first node PU will continuously decline due to electric leakage, resulting in that the voltage of the first node PU is 11.8 V during further pull-up for a second time, but the drive output end will output the high level, so as to keep a normal output waveform of the drive output end. That is to say, when the voltage of the first node PU is 11.8 V, the switching transistor M3 may be controlled to be normally turned on. Exemplarily, taking a 6.1-inch EPD product and the active level being the high level as an example, the EPD product has eight clock signal lines, the drive frequency is 50 Hz, the total number of the pixel rows is 600, time for each row is 30 us (containing a time slot of adjacent rows), a duration in which the high level serving as the first active level in the first clock signal is maintained is about 25 us (there is a time slot in adjacent rows), the first node PU in the shift register does not reach a peak during first pull-up, and the voltage is 16 V. Since an interval between the high levels of the first active level is lowered, the voltage of the first node PU declines less due to the electric leakage, the voltage of the first node PU is 16 V during further pull-up for the second time, and the drive output end will output the high level, so as to keep the normal output waveform of the drive output end. That is to say, when the duration in which the first active level is maintained is shortened, and the clock period where the first active level is located is shortened, the first node PU may also control the switching transistor M3 to be normally turned on. Thus, through the above two sizes of EPD product verification, the non-refresh region does not affect normal work of normal shift register structures by making the duration in which the first active level is maintained be reduced.

The embodiments of the present disclosure further provide a driving apparatus for a display panel, as shown in FIG. 1, including:
a determining circuit 210, configured to determine, when in a first driving mode, a refresh region and a non-refresh region in the display panel; and
a clock output circuit 220, configured to input a first clock signal to a gate drive circuit in the display panel according to the refresh region and the non-refresh region, such that the gate drive circuit outputs a first gate scan signal to a gate line in the non-refresh region, and outputs a second gate scan signal to a gate line in the refresh region, where a duration in which an active level of the first gate scan signal is maintained is less than a duration in which an active level of the second gate scan signal is maintained.

In some embodiments of the present disclosure, the clock output circuit 220 is further configured to input, when in a second driving mode, a second clock signal to the gate drive circuit in the display panel, such that the gate drive circuit outputs a third gate scan signal to each gate line, and loads a data line with a drive data voltage when outputting an active level of the third gate scan signal to the gate line, such that a pixel refreshes a display image, where, durations in which the active levels of the third gate scan signals are maintained are the same.

In some embodiments of the present disclosure, the driving apparatus 200 further includes a source drive circuit 230. The source drive circuit 230 is configured to load the data line with a set fixed voltage when outputting the active level of the first gate scan signal to the gate line in the non-refresh region, such that the pixel keeps the display image; and load the data line with a drive data voltage when outputting the active level of the second gate scan signal to the gate line in the refresh region, such that the pixel refreshes the display image.

In some embodiments of the present disclosure, the source drive circuit 230 is further configured to load the data line with the drive data voltage when outputting the active level of the third gate scan signal to the gate line in the non-refresh region, such that the pixel refreshes the display image.

It needs to be noted that the driving principle and specific implementations of the driving apparatus are the same as the principle and implementations of the driving method of the above embodiment, thus, the working process of the driving apparatus may refer to the specific implementation of the driving method of the above embodiment for implementation, which is not repeated here.

Based on the same disclosure conception, the embodiments of the present disclosure further provides a display apparatus, including the above display panel and driving apparatus provided by the embodiments of the present disclosure. The principle of the display apparatus solving the problem is similar to that of the above-mentioned driving apparatus, thus, the implementation of the display apparatus may refer to the implementation of the above-mentioned driving apparatus, and repetitions will be omitted.

During specific implementation, in the embodiments of the present disclosure, the display apparatus may be an EPD display apparatus. For example, the display apparatus may be an electronic price tag and the like. Other essential components of the display apparatus should be understood by those ordinary skilled in the art, which is not repeated here, and should not be understood as limitations to the present disclosure.

According to the driving method for the display panel, the driving apparatus for the display panel and the display apparatus provided by the embodiments of the present disclosure, by determining the refresh region and the non-refresh region in the display panel, the first clock signal may be input to the gate drive circuit according to the determined refresh region and non-refresh region, such that the gate drive circuit may output different gate scan signals to the gate lines in the non-refresh region and the refresh region, that is, the first gate scan signal is output to the gate line in the non-refresh region, and the second gate scan signal is output to the gate line in the refresh region. In addition, the duration in which the active level of the first gate scan signal is maintained is made to be less than the duration in which the active level of the second gate scan signal is maintained, in this way, scanning time of the non-refresh region may be shortened, and thus, the overall scanning time is shortened.

Apparently, those skilled in the art can make various modifications and variations to the present disclosure without departing from the spirit and scope of the present disclosure. In this way, if these modifications and variations of the present disclosure fall within the scope of the claims of the present disclosure and their equivalent art, the present disclosure also intends to include these modifications and variations.

1. A driving method for a display panel, comprising:
determining, when in a first driving mode, a refresh region and a non-refresh region in the display panel; and
inputting a first clock signal to a gate drive circuit in the display panel according to the refresh region and the non-refresh region, such that the gate drive circuit outputs a first gate scan signal to a gate line in the non-refresh region, and outputs a second gate scan signal to a gate line in the refresh region; wherein a duration in which an active level of the first gate scan signal is maintained is less than a duration in which an active level of the second gate scan signal is maintained.

2. The driving method for the display panel according to claim 1, wherein an active level of the first clock signal is used for outputting the active levels of the first gate scan signal and the second gate scan signal; and
the active level of the first clock signal for outputting the active level of the first gate scan signal is defined as a first active level, the active level of the first clock signal for outputting the active level of the second gate scan signal is defined as a second active level, and a duration in which the first active level is maintained is less than a duration in which the second active level is maintained.

3. The driving method for the display panel according to claim 2, wherein a clock period where the first active level is located is smaller than a clock period where the second active level is located.

4. The driving method for the display panel according to claim 3, wherein the gate drive circuit comprises a plurality of shift registers, one shift register is coupled with one gate line, the plurality of shift registers are divided into a plurality of register groups, and a same register group receives a same first clock signal; and, at least one gate line coupled with other register groups are provided between gate lines coupled with two adjacent shift registers in the same register group; and
the inputting the first clock signal to the gate drive circuit in the display panel according to the refresh region and the non-refresh region, such that the gate drive circuit outputs the first gate scan signal to the gate line in the non-refresh region, and outputs the second gate scan signal to the gate line in the refresh region, comprises:
inputting the first clock signal having the first active level and the second active level to the same register group according to the refresh region and the non-refresh region, such that the same register group outputs the first gate scan signal to a gate line coupled thereto located in the non-refresh region, and outputs the second gate scan signal to a gate line coupled thereto located in the refresh region.

5. The driving method for the display panel according to claim 4, wherein for the first clock signal input to the same register group, the duration in which the first active level is maintained is not greater than ½ of the duration in which the second active level is maintained.

6. The driving method for the display panel according to claim 5, wherein durations in which first active levels of first clock signals input to different register groups are maintained are the same;
and/or, durations in which second active levels of the first clock signals input to the different register groups are maintained are the same.

7. The driving method for the display panel according to claim 4, wherein the first clock signal comprises a 1st first clock signal to an 8th first clock signal;
the plurality of register groups comprise a 1st register group to an 8th register group, wherein the 1st register group is coupled with an (8k−7)^{th} gate line; the 2nd register group is coupled with an (8k−6)^{th} gate line; the 3rd register group is coupled with an (8k−5)^{th} gate line; the 4th register group is coupled with an (8k−4)^{th} gate line; the 5th register group is coupled with an (8k−3)^{th} gate line; the 6th register group is coupled with an (8k−2)^{th} gate line; the 7th register group is coupled with an (8k−1)^{th} gate line; the 8th register group is coupled with an 8k^{th} gate line; k is an integer larger than 0; and
at least one first clock signal from the 1st first clock signal to the 8th first clock signal has the first active level and the second active level.

8. The driving method for the display panel according to claim 1, further comprising:
loading a data line with a set fixed voltage when outputting the active level of the first gate scan signal to the gate line in the non-refresh region, such that a pixel keeps a display image; and loading the data line with a drive data voltage when outputting the active level of the second gate scan signal to the gate line in the refresh region, such that the pixel refreshes the display image.

9. The driving method for the display panel according to claim 8, wherein the display panel comprises a common electrode; and
the driving method further comprises: loading the common electrode with a common electrode voltage, wherein
the set fixed voltage is the common electrode voltage.

10. The driving method for the display panel according to claim 1, further comprising:
inputting a second clock signal to the gate drive circuit in the display panel when in a second driving mode, such that the gate drive circuit outputs a third gate scan signal to each gate line, and loads a data line with a drive data voltage when outputting an active level of the third gate scan signal to the gate line, such that the pixel refreshes a display image, wherein durations in which active levels of various third gate scan signals are maintained are the same.

11. The driving method for the display panel according to claim 1, wherein the display panel comprises an electrophoresis display.

12. A driving apparatus for a display panel, comprising:
a determining circuit, configured to determine, when in a first driving mode, a refresh region and a non-refresh region in the display panel; and
a clock output circuit, configured to input a first clock signal to a gate drive circuit in the display panel according to the refresh region and the non-refresh region, such that the gate drive circuit outputs a first gate scan signal to a gate line in the non-refresh region, and outputs a second gate scan signal to a gate line in the refresh region; wherein a duration in which an active level of the first gate scan signal is maintained is less than a duration in which an active level of the second gate scan signal is maintained.

13. The driving apparatus for the display panel according to claim 12, further comprising a source drive circuit, wherein
the source drive circuit is configured to load a data line with a set fixed voltage when outputting the active level of the first gate scan signal to the gate line in the non-refresh region, such that a pixel keeps a display image; and load the data line with a drive data voltage when outputting the active level of the second gate scan signal to the gate line in the refresh region, such that the pixel refreshes the display image.

14. A display apparatus, comprising the display panel and the driving apparatus for the display panel according to claim 12.
